(19) United States
(12) Patent Application Publication
(10) Pub. No.: US 2012/0072029 A1
(43) Pub. Date: Mar. 22, 2012

(54) INTELLIGENT SYSTEM AND METHOD FOR DETECTING AND DIAGNOSING FAULTS IN HEATING, VENTILATING AND AIR CONDITIONING (HVAC) EQUIPMENT

(75) Inventors: Gerald Persaud, Nepean (CA); Greg Hiebert, Nepean (CA); Eric Granger, Montreal (CA)

(73) Assignee: HEATVU INC., Nepean (CA)

(21) Appl. No.: 12/885,753

(22) Filed: Sep. 20, 2010

(51) Int. Cl. G05B 13/04; G06F 15/18; G06N 5/02

(52) U.S. Cl. 700/276; 706/54; 706/52; 706/12

(57) ABSTRACT

A system and a method for detecting and diagnosing faults in heating, ventilating and air conditioning (HVAC) equipment is described. The system comprises a sensor; a classifier modelling a normal behaviour of the HVAC equipment in situ in the installed operation environment, the classifier having a plurality of classifier parameters for computing a classifier score using an input data based on a measured value from the sensor, the plurality of classifier parameters being created during a training phase of the system using the input data during the training phase; and a decision module for comparing the classifier score to a decision threshold, the decision threshold being set during the training phase.

### FIELD OF INVENTION

The present invention relates to a heating, ventilating and air conditioning (HVAC) equipment, and more particularly to an HVAC fault detection and diagnosis (FDD) system.

### BACKGROUND OF THE INVENTION

HVAC systems are widely used in residential and commercial buildings, and as such consume a large amount of energy throughout the world. So, even small inefficiencies over all HVAC systems results in significant waste of energy. In 2004, the National Energy Management Institute (NEMI) published a residential HVAC market research which estimated that out of about 100 million furnaces in the US, less than 20 million were serviced each year. Improperly maintained HVAC systems, even as simple as a dirty filter, can lead to 10 to 20% loss in efficiency, which results in increased cost for the homeowner while producing unnecessary green house gas into the environment. For example, a report on climate change by the Yukon Government estimated that an improperly maintained furnace produces an extra 2.1 tonnes of carbon dioxide annually.

While governments have attempted to address this problem by providing incentives for homeowners to replace low-efficiency furnaces (less than 80% efficiency) with high-efficiency furnaces (90% or more efficiency), the incentives are often insufficient to entice a homeowner to purchase a costly high-efficiency furnace. For example, the Canadian government's ecoENERGY program offered rebates toward a high-efficiency furnace that fell well below the actual cost of a high-efficiency furnace. However, the benefits of a new high-efficiency furnace are negated if it is not maintained properly.

A cost effective solution consists in maintaining an HVAC system at a high level of efficiency. However, despite governments' efforts to educate the public about the benefits of a well maintained HVAC system, the majority of homeowners do not perform regular maintenance. The main reason is that maintenance plans are expensive and homeowners have no guidance on the level of maintenance required on their HVAC system. Consequently, the majority of homeowners choose to service the equipment only when it fails. By this time, the HVAC system may have been underperforming for years.

Several attempts have been made to address this problem by employing some form of fault detection and diagnostics (FDD). Automated FDD concerns the processes of automatically detecting faults with physical systems and diagnosing their causes.

One such attempt is disclosed in U.S. Pat. No. 6,658,372 to Abraham et al. The FDD system described in U.S. Pat. No. 6,658,372 monitors various functions of the furnace and generates data for diagnosis. To prevent misdiagnosis, a history of the data is stored and can be used to assess similar problems. However, this approach requires time consuming intervention and assessment by an experienced technician making it costly to diagnose large numbers of HVACs. Moreover, the surrounding environment or equipment may significantly change over time, thus rendering historical data marginally useful.

FDD methods can be classified into two broad categories, model-based methods and data-based methods. The two categories differ by the knowledge used to diagnose the cause of faults, although both may use simulation models and measurement data. Model-based methods use explicit prior knowledge of HVAC systems to identify the differences between model simulation results and actual operation measurements. Models are detailed mathematical descriptions of the HVAC equipment, and are configured using design information and component manufacturers' data, and then fine-tuned to match the actual performance of the HVAC equipment by using data measured during functional tests. Data-based methods are derived models from process history data, and learn the relationship between driving conditions, device construction, and normal operating states from data.

Model-based methods are further divided into quantitative and qualitative modeling methods. Quantitative models are based on mathematical relationship derived from the underlying physical knowledge, and rely on explicit mathematical models of a system to detect and diagnose faults. By understanding the physical relationships of an HVAC system, mathematical equations to represent each component of the system can be developed and solved to simulate its steady and transient behaviour of the systems. In contrast, qualitative modeling uses rule-based methods developed based on prior knowledge. Qualitative rule relationships are employed to detect and diagnose faults instead of quantitative mathematical equations. The rules are derived from expert knowledge, process history data and quantitative models simulation data. Expert knowledge is normally summarized to a database in the form of if-then-statements.

Producing such physical models for practical HVAC equipment, either analytically or via simulation, is usually very difficult due to the complex thermo-dynamical relationship between external driving conditions and the details of HVAC equipment fabrication. Existing models, have had limited success in producing accurate estimates of expected operating states as a function of driving condition. In addition, although models are commonly based on physical principles, they may not properly fit the process data, and cannot explain systematic variation. This is the driving motivation behind the use of data-based models.

Automatic model-based FDD systems have also been attempted in various forms. One such form is the use of a model based FDD system to determine the performance of the HVAC system. For example, in U.S. Pat. No. 6,223,544 to Seem, fault detection is achieved by employing a finite state machine. Upon transition, it compares the actual performance of the HVAC system to that of the FSM model. Another example is the HVAC monitoring system disclosed in U.S. Pat. No. 6,385,510 to Hoog et al., which continuously monitors the general condition and efficiency of the HVAC system. The monitored values are then compared against optimum values for an HVAC system of the size and capacity being monitored by means of industry standard tables and equations. In both systems, a disadvantage is that the model/industry standard HVAC system is not customized to account the actual environment where the HVAC system operates. Moreover, the model/industry standard HVAC system does not consider the conditions particular to the HVAC installation and other external conditions such as the weather. This may lead to inaccurate diagnosis and false alarms.

Data-based methods are subdivided into black-box and gray-box methods. They differ on the physical meaning of their model parameters. Black-box methods use non-physical based relationship to represent the characteristics of a system. Model parameters do not represent actual physical properties. Black box methods often employ techniques such as linear or multiple linear regression, statistical or neural network classification, and fuzzy logic. In a gray-box model, the model parameters are determined based on physical principles. Parameter estimation techniques are often used to obtain those parameters from measurement data. Gray-box modeling typically requires higher-level of expertise than black-box modeling to form the model parameters and estimate parameter values. Data-based methods are completely driven by recorded measurement data, yet do not always generate good process insight.

There have also been prior attempts at data-based FDD systems that learn the expected behaviour of a particular appliance (e.g. HVAC equipments). In U.S. Pat. No. 5,706,191 to Bassett et al., an appliance interface apparatus (AIM) is designed to allow various home appliances to communicate with one another and to accept commands remotely in managing the residence autonomously. AIM monitors various sensors to ensure that the home appliances, for example, gas furnace is functioning properly. This is achieved by first “learning” the expected behaviour of the particular appliance (e.g. offset between a thermostat setting and the return air temperature, delays in ignition sequences). Thereafter, AIM watches for deviations from such expected values. One of the disadvantages of this system is that the system only learns simple expected values without truly creating a comprehensive input-to-output mapping among all the parameters. Therefore, without an overall, comprehensive picture of all the parameters, a non-optimal parameter may skew the outlook of the system, resulting in false alarms.

In U.S. Pat. No. 7,444,251 to Nikovski et al., a locally weighted regression model is generated using training data from healthy HVAC equipment. This allows us to predict the value of observed state variables under normal operation of the HVAC equipment, given the input driving conditions. Second, using prediction residuals from the regression model and observed values of the state variables, they train classifiers to distinguish between three fault conditions of operation of the equipment (normal, overcharged and undercharged). It is trained using data collected from faulty HVAC equipment in abnormal conditions. Once learned, the regression model is used to detect signal readings that deviate significantly from the expected values for normal operation. Once a faulty state has been detected, the classifier establishes the specific type of fault condition. One of the disadvantages of this system is that the regression model is generated using training data that are not particular to the environment where the HVAC system is installed. The black-box methods used in this approach are trained using data collected in a laboratory from normal and abnormal condition, and will provide a lower accuracy because they do not account or personalize for the specific HVAC installation and environment. Further, the techniques employed for locally weighted regression and for classification do not allow for automated on-line incremental learning to update or refine models without retraining from the start using all available training data. Training a locally weighted regression model with laboratory data is generally less tolerant to deviations from the pre-set conditions. As such, it is regular practice to include tolerances that contribute to the inefficiencies of the system.

Therefore, there is a need for a low-cost HVAC FDD system that accurately detects degradation in performance and automatically notifies the homeowner of actions to take in correcting the problem. Further, there is a need to generate data-driven FDD models that are personalized for an HVAC installation, using data collected from the specific equipment under different conditions in situ. There is further a need for on-line incremental learning to adapt such black-box models over time with a comprehensive input-output mapping among all parameters.

### SUMMARY OF THE INVENTION

According to an aspect of the present invention there is provided a system for detecting and diagnosing faults in heating, ventilating and air conditioning (HVAC) equipment. The system comprises a sensor, a classifier modelling a normal behaviour of the HVAC equipment in situ in the installed operation environment, and a decision module for comparing the classifier score to a decision threshold, the decision threshold being set during the training phase. The classifier has classifier parameters for computing a classifier score using an input data based on a measured value from the sensor. The classifier parameters are created during a training phase of the system using the input data during the training phase.

Preferably, the system further comprises a second classifier modelling a fault condition of the HVAC equipment, the second classifier has classifier parameters for computing a second classifier score using the input data. The classifier parameters are created during the training phase using the fault condition of the HVAC equipment detected during a monitoring phase of the system.

Preferably, the system further comprises a communication module for communicating the classifier score to a remote server when the classifier score is below the decision threshold and for receiving instructions from the remote server; and a control module for controlling the HVAC equipment based on the instructions from the remote server.

Preferably, the system further comprises a filtering and converting module for filtering and converting the measured value from the sensor into digital data, the digital data being the input data to the classifier.

Preferably, during a transient state operation, the digital data is further input into a windowing module for extracting invariant and discriminate features, the windowing module outputs the input data for the classifier.

Preferably, the system further comprises a performance degradation estimator for estimating degradation in performance of the HVAC equipment based on the classifier score and the input data.

Preferably, the performance degradation estimator estimates degradation in efficiency.

Preferably, the system further comprises a memory for storing the plurality of classifier parameters, the decision threshold, the measured value and the input data used during the training phase.

Preferably, the communication module includes a wireless transceiver for communicating with the remote server.

Preferably, the system further comprises a thermostat bypass relay to enable and disable overriding of the control module by a local switch or remote server.

Preferably, the sensor is selected from the group consisting of: a flue gas temperature sensor, a return air temperature sensor, a return air humidity level sensor, a supply air temperature sensor, a supply air flow sensor, a supply air carbon monoxide level sensor, an outside temperature sensor, an outside humidity level sensor, a room temperature sensor, a room humidity level sensor and a combination thereof.

According to another aspect of the present invention there is provided a method for detecting and diagnosing faults in heating, ventilating and air conditioning (HVAC) equipment, comprising: measuring an input data from a sensor; inputting the input data from the sensor into a classifier modelling a normal behaviour of the HVAC equipment in situ in the installed operation environment, the classifier having a plurality of classifier parameters determined during a training phase of the classifier; calculating a classifier score using the plurality of classifier parameters and the input data; comparing the classifier score to a decision threshold set during the training phase; and communicating the classifier score to a remote server.

Preferably, the training phase comprises: sampling the sensor and estimating the plurality of classifier parameters; calculating the classifier score using the plurality of classifier parameters and the initial data until the classifier score is constant over a pre-defined number of successive repetitions or until a maximum number of repetitions are performed; and setting the decision threshold based on the plurality of classifier parameters.

Preferably, the method further comprises diagnosing the HVAC equipment to determine a fault condition; storing information related to the fault condition; creating a second classifier modelling the fault condition, the second classifier having a second plurality of classifier parameters based on the stored information; training the second classifier comprising: sampling the sensor; estimating the second plurality of classifier parameters based on the stored information related to the fault condition; calculating the classifier score using the second plurality of classifier parameters and the sampled data from the second sensor until the classifier score is constant over a pre-defined number of successive repetitions or until a maximum number of repetitions are performed; and setting the decision threshold based on the plurality of classifier parameters; and monitoring the HVAC equipment with the classifier modelling the normal behaviour and the classifier modelling the fault condition of the HVAC equipment.

Preferably, the stored information comprises the measured data, the input data, the classifier score, the classifier parameters, and the decision threshold related to the fault condition.

Preferably, inputting comprises filtering and converting the measured data from the sensor into digital data, the digital data being the input data to the classifier.

Preferably, wherein, during a transient state operation, inputting further comprises extracting invariant and discriminate features from the digital data, the digital data being the input data to the classifier.

Preferably, the method further comprises estimating degradation in performance of the HVAC equipment based on the input data and the classifier score.

### BRIEF DESCRIPTION OF THE DRAWINGS

These and other features of the invention will become more apparent from the following description in which reference is made to the appended drawings wherein:

FIG. 1 is a high-level system diagram depicting the use of the intelligent FDD system in accordance with an embodiment of the present invention;

FIG. 2 is a block level diagram of the FDD system in accordance with an embodiment of the present invention;

FIG. 3 is a detailed block level diagram of the classification and decision modules of the FDD system in accordance with an embodiment of the present invention;

FIG. 4 is a schematic diagram depicting an implementation of the FDD system in accordance with an embodiment of the present invention;

FIG. 5 is a flow chart describing the training and monitoring phases of the FDD system in accordance with an embodiment of the present invention; and

FIG. 6 is an exemplary performance report generated by the remote server in accordance with another embodiment of the present invention.

### DETAILED DESCRIPTION

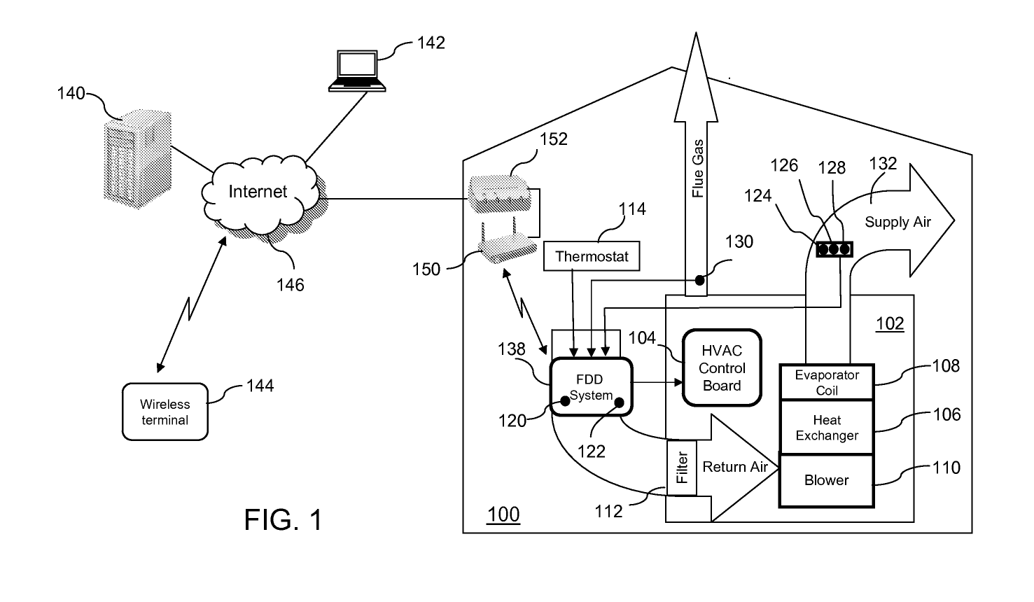

A high-level system diagram of the intelligent FDD system for HVAC equipment, in accordance with one embodiment of the present invention, is shown in FIG. 1. HVAC equipment 102 for heating, ventilating and air conditioning is located in a substantially enclosed building, for example, a house 100. The HVAC equipment 102 is a typical system which may include a control board 104, a heat exchanger 106, a evaporator coil 108, a blower 110, a filter 112, and a thermostat 114. During operation of an exemplary HVAC equipment, a user sets the desired parameters, for example but not limited to, humidity or temperature on the thermostat 114, which informs the control board 104 to start the blower 110. The blower 110 draws in return air through the filter 112. This air is then heated by the heat exchanger 106 or cooled by the evaporator coil 108 and re-supplied to the house 100 through the supply air path. The exhaust produced by the HVAC equipment 102 is expelled outside as flue gas.

In one embodiment of the present invention, various sensors are installed within the HVAC equipment to sample the performance of the system. In the exemplary embodiment as shown in FIG. 1, temperature 120 and humidity 122 sensors, are installed in the return air path. Temperature 124, carbon monoxide 126 and air flow 128 sensors are installed in the supply air path 132, and temperature sensor 130 is installed in the flue gas exit path. In other embodiments, additional sensors may be installed to measure other environmental conditions, for example but not limited to, external temperature, external humidity. Such external conditions may also be provided by the thermostat 114 or the local weather stations (not shown). These sensors allow comprehensive sampling of the performance of the HVAC equipment, which is then analyzed by the FDD system 138. The FDD system 138 is able to control the HVAC equipment through the control board 104. It is also able to communicate with a remote system, such as a remote server 140, a computer 142 or a wireless terminal 144, for example but not limited to, a smart phone through the Internet 146. In one embodiment, communication is established wirelessly by a wireless adapter 150 that is plugged into the homeowner's local internet access device 152. The remote server 140 allows further processing of the information communicated by the FDD system 138. Furthermore, the FDD system 138 may be controlled remotely, for example but not limited to, by a remote server 140, a computer 142 or a smart phone 144. While the FDD system 138 is designed to autonomously maximize the efficiency of the HVAC equipment 102, its control of the HVAC equipment 102 may be manually overridden. However, the FDD system 138 may still continue to monitor and report the performance of the HVAC equipment 102. In the illustrated embodiment in FIG. 1, the FDD system 138 is separate from the HVAC control board 104, however, it should be apparent to a person skilled in the art that the FDD system 138 and the HVAC control may reside on the same board, or the HVAC control board 104 may be implemented as a HVAC control module.

### Fault Detection and Diagnosis (FDD) System

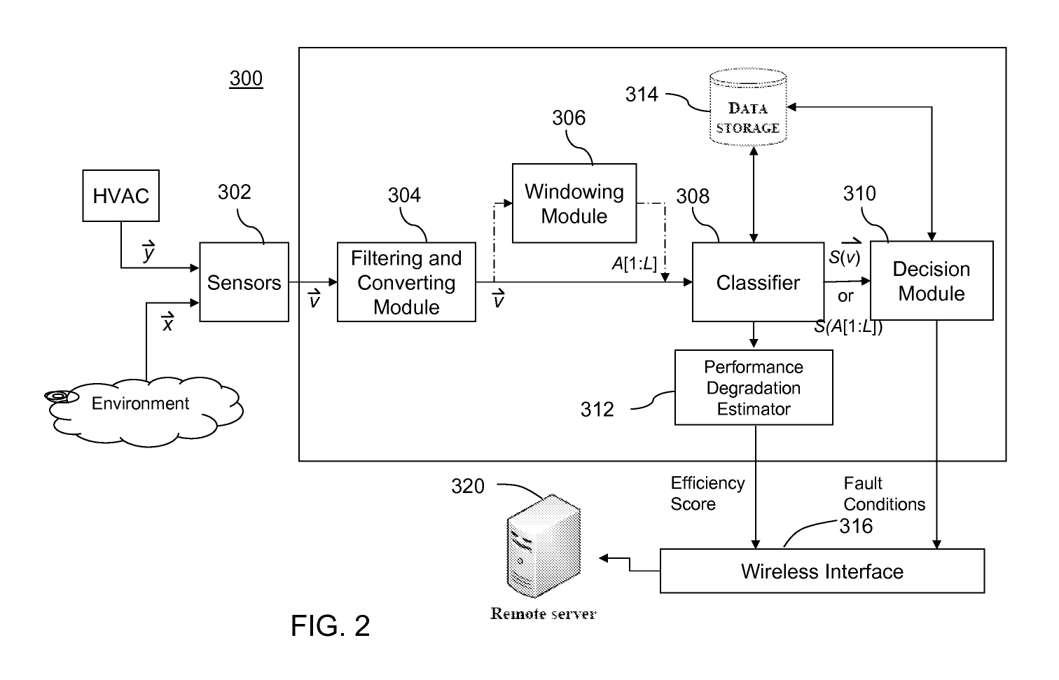

Referring to FIGS. 1 and 2, a block level diagram of the FDD system 300 in accordance with an embodiment of the present invention is shown. The sensors 302 in communication with the FDD system 300 receive raw data \vec{x}, \vec{y}, \vec{x}=(x₁(t), x₂(t), . . . , xₘ(t)): vector that stores for external driving conditions, e.g., internal room temperature and humidity, \vec{y}=(y₁(t), y₂(t), . . . , yₚ(t)): vector that stores sampled internal state variable from n sensors installed within a HVAC system, e.g., supply and return air temperature, return humidity and pressure, and \vec{y}=(x₁(t), x₂(t), . . . , xₘ(t); y₁(t), y₂(t), . . . , yₚ(t))=(v₁(t), v₂(t), . . . , vₘ₊ₚ(t)): a feature vector that includes a concatenation of \vec{x} and \vec{y} vectors. As described in the above, the sensors may be installed throughout the HVAC equipment, and optionally throughout the home to measure conditions external to the HVAC equipment as mentioned above. For example, the home may be installed with a plurality of sensors to measure flue gas temperature (e.g. sensor 130), return air temperature (e.g. sensor 120), return air humidity levels (e.g. sensor 122), supply air temperature (e.g. sensor 124), supply air carbon monoxide levels (e.g. sensor 126) or supply air flow (e.g. sensor 128). There may also be sensors that measure the external driving conditions of the HVAC equipment. For example, internal room temperature and humidity level of the house may be measured and taken into consideration. Measurement of the external driving conditions may be done by separate sensors installed throughout the home (outside and inside) or by existing hardware, such as the thermostat 114. Alternatively or additionally, conditions external to the HVAC equipment may be provided by external sources such as the local weather station.

The raw data \vec{x}, \vec{y}, \vec{v}, from the sensors 302 are then received by the filtering and converting module 304 for signal conditioning and conversion into digital data. In the filtering and converting module 304, raw data is converted into digital data, for example, by using an analog to digital converter (ADC). The output \vec{v} from the filtering and converting module 304 becomes the input data into the classifier 308. Optionally, where the FDD system 300 is for use in a transient state operation, a windowing module 306 may be included. The windowing module 306 is required because the measured data from the sensors 302 is a sequence of ordered samples in a transient environment. During the transient operation, for example, when the furnace fires-up, the sampled signals may vary in time. Therefore, a sequence of measurements from one or more sensors over a window of time may need to be observed. Thus, the windowing module 306 is used to extract a window of those ordered samples A[1: L] for use in the classifier 308. In other words, the windowing module 306 assembles a sensor's symbols into a chronological sequence of consecutive symbols, where the number of symbols per sequence is defined by the window length L. On the other hand, at some time after fire up, the stead state operation of the furnace may be observed, once measured data stop varying over time. During the steady state operation, one sample is collected at a time, looking at all sensor measurements.

In one exemplary embodiment of steady-state operation, the input \vec{v} to the classifier 308 is the direct output from the filtering and converting module 304. In another exemplary embodiment of transient-state operation, the input to the classifier 308 is further processed by the windowing module, to produce fixed-size sequences according to some length L. A[1: L]=v(1), v(2), . . . , v(L): a sequence of chronologically ordered values sampled from a state variable i in \vec{v}. This module is only relevant for monitoring transient state of input signals over time. The classifier 308 matches the input data to a model of either normal HVAC behaviour, or of some fault condition, and produces a classifier score that is either an indication of the overall performance of the HVAC equipment or the occurrence of some fault condition. For FDD system 300 in the steady-state operation, the classifier 308 may be based on various one-class classifiers or density estimation algorithms, for example but not limited to, the Gaussian Mixture Model (GMM) or the one-class Support Vector Machine (SVM). For FDD system 300 in the transient-state operation, the sequence classifier 308 may be based on, e.g., the Hidden Markov Model (HMM) classifier. By using the classifier 308, which is described in detail below, degradation in performance and fault detection may be detected with high accuracy since the classifier 308 is trained in situ, i.e. while the HVAC equipment is running, using real data samples measured from the particular HVAC equipment installation and the surrounding environment. This allows the FDD system 300 to adapt to the particular intricacies of the HVAC FDD monitoring equipment as installed and not on an ideal or industry standard data.

The output of the classifier 308 is a classifier score S(A[1: L]) or S(\vec{v}) that is used by the decision module 310 to assess the operating conditions and fault conditions of the HVAC system. This is achieved by comparing the classifier score to a decision threshold set during the training phase of FDD system 300. Similarly to the classifier 308, the decision threshold may be selected based on the in situ data samples measured from the HVAC equipment and the surrounding environment. When the performance of the HVAC system falls below a certain threshold or when a fault condition is detected, the FDD system 300 provides a notification to, for example but not limited to, the remote server 320 for verification and further instructions. In one embodiment, notification to the remote server 320 is accomplished through a wireless interface 316. Also, data samples from the conditions that triggered the fault may be stored in memory 314. For example, the raw measured data from the sensors 302, the input data to the classifier 308, the classifier parameters, the classifier score, and the decision threshold that triggered the fault may all be stored in memory 314. The classifier score and input data may also be used by a performance degradation estimator 312, which provides relationship between classifier score and the performance of the HVAC system, and to estimate the overall degradation in efficiency of the HVAC equipment based on the classifier score and the input data. For example, the efficiency may be estimated based on the physical properties of HVAC equipment using measured data samples. The result of the estimated performance degradation may be communicated to the remote server 320, which may be taken into consideration in determining the next step of the monitoring process.

### Classification and Decision Modules

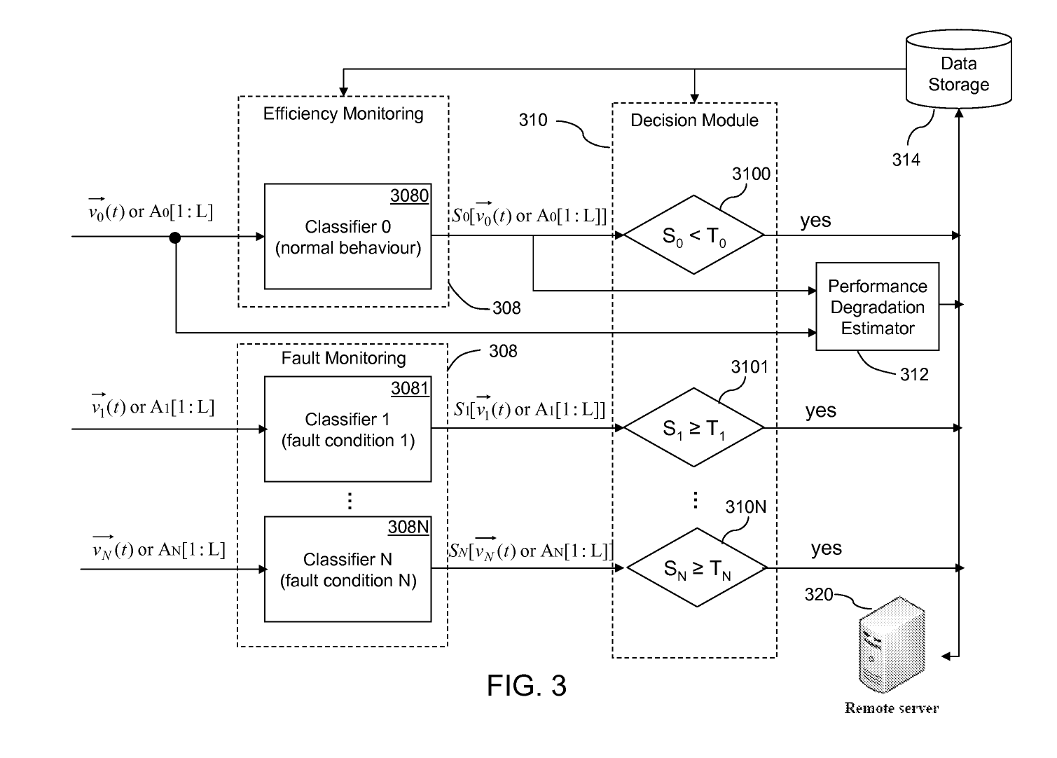

Referring to FIG. 3, classifier 308, decision module 310, performance degradation estimator 312, data storage 314 and remote server 320 as shown in FIG. 2 are described.

The classification system 308 may comprise N one-class classifiers 3080, 3081, . . . 308N. Classifier 3080 is defined by a plurality of classifier parameters, which are estimated during the training phase using real data samples measured in situ from the particular HVAC equipment installation and the surrounding environment. Then, during the monitoring phase, using the plurality of classifier parameters estimated during the training phase, classifier 3080 is used to compare input samples from sensors to the normal system behaviour of the HVAC equipment.

The classifier 308 may also have classifiers 3080, 3081, . . . 308N. to monitor for a specific fault condition of the HVAC equipment. The classifiers 3080, 3081, . . . 308N are trained using data collected according to fault conditions specifically diagnosed during the operation of the HVAC equipment as discussed below.

One-class classification refers to a special type of pattern recognition problem. Let C₀ be a certain class of interest. For input vector \vec{v} or input sequence A[1: L], a one-class classifier outputs a score S(\vec{v}) or S(A[1: L]) that indicates the confidence or likelihood that the input produced was sampled from C₀. If the input does not belong to C₀, it is called an anomaly (or a novelty). Generally, the objective of training a one-class classifier is to estimate the parameters that correspond to an efficient mapping between the input sample space, say \vec{Z}, and class C₀. That mapping defines the decision region R₀ for class C₀ such that R₀={\vec{Z}: f(\vec{Z})≧T}, where T is a decision threshold. If f(\vec{Z})≧T, \vec{Z} is classified as C₀ (familiar or normal behaviour); otherwise, \vec{Z} is classified as C₁ (unfamiliar or abnormal behaviour).

The input to the classifiers 3080, 3081, . . . 308N depends on whether the FDD system 300 is used to analyze steady-state or transient state operation. For steady-state operations, the input to a classifier i among 3080, 3081, . . . 308N is a vector \vec{v}ᵢ(t), where t represents time at which the HVAC equipment, the external environment or both were sampled. For transient state operations, the input to a classifier i among 3080, 3081, . . . 308N is a sequence Aᵢ[1: L] output from the windowing module 306. Aᵢ[1 L] is a sequence of ordered samples captured by the windowing module according to a window of length L, from the HVAC equipment or the external environment or both. The classifier 3080 is trained to operate on normal conditions, while classifiers 3081, . . . 308N are trained and operate independently based on specific fault conditions.

With the inputs, classifiers 3080, 3081, . . . , 308N produce classifier scores S₀, S₁, . . . S_{N} that are input into the decision module 310. The decision module 310 compares respective scores to decision thresholds T₀, T₁, . . . T_{M}. In the exemplary embodiment shown in FIG. 3, there is one decision threshold, 3100, 3101, . . . 310N for each classifier 3080, 3081, . . . 308N. For classifier 3080, the score S₀ indicates the likelihood that an input sample (measures from the current behaviour of the HVAC equipment) corresponds to the behaviour of the HVAC equipment when it was initially tuned in situ in the installed environment. If the classifier score S₀ falls below the minimum threshold T₀, a flag is raised, which is then communicated to the remote server 320. The administrator at the remote server 320 may perform further analysis before notifying the homeowner of the anomaly in the HVAC equipment. The flag, along with accompanying data such as inputs \vec{v}₀(t) or A₀[1: L], classifier parameters of the classifier 3080, classifier score S₀, and decision thresholds T₀ may also be stored in memory 314. If the FDD system 300 includes a performance degradation estimator 312, for example, for estimating efficiency of the system, the output of the performance degradation estimator 312 may also be communicated to the remote server 320 and stored in data storage 314.

The classifier 308 may include additional classifiers 3081, . . . 308N, and the FDD system 300 may also monitor fault conditions. With the inputs vector \vec{v}₁(t), a sequence A₁[1: L], the classifiers 3081, . . . 308N produce scores S₁ . . . S_{N} which are compared against decision thresholds T₁ . . . T_{N} to determine whether specific fault conditions arose. If one of the score S₁ . . . S_{N} exceed or is equal to the maximum allowed threshold T₁ . . . T_{N}, a fault flag is raised, which is again communicated to the remote server 320. Data samples relevant to the fault flag may also be stored in memory 314.

While the above was described using one-class classifiers, two-class or multi-class classifiers are also reasonably contemplated within this invention. However, the training phase requires that the classification parameter be re-estimated with data samples from both normal and abnormal behaviour.

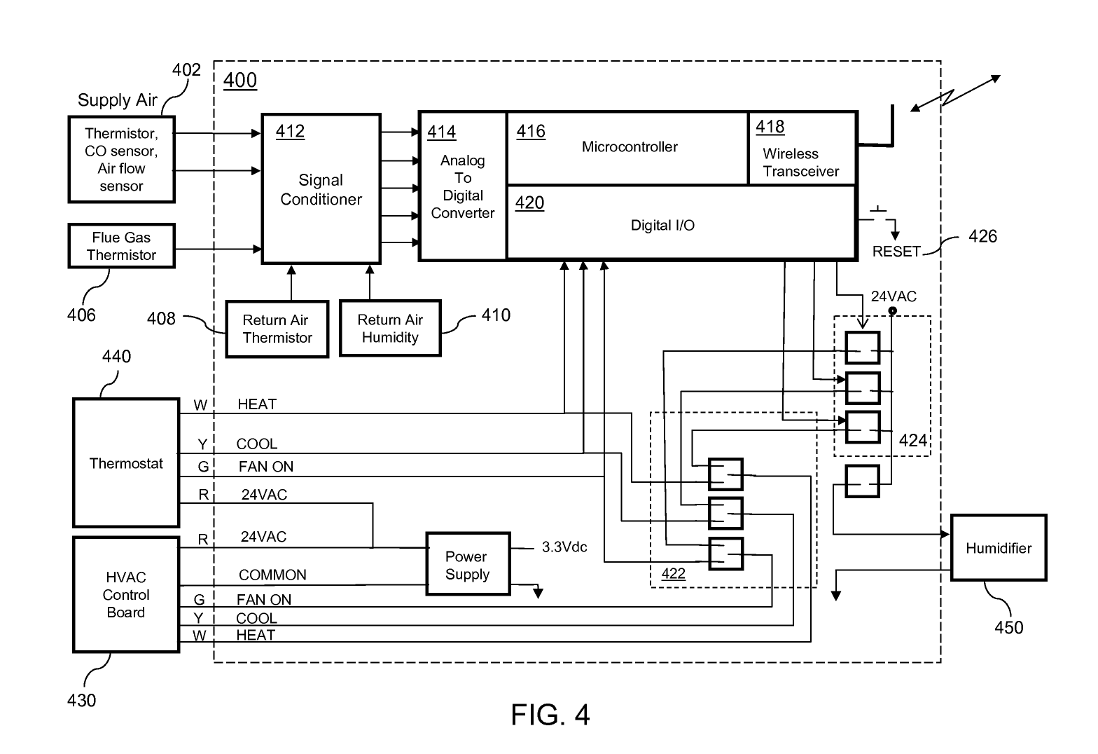

A schematic diagram of an embodiment of a FDD system 400, which implements an embodiment of the FDD system 300 discussed above, is shown in FIG. 4. The FDD system 400 samples the parameters of the HVAC equipment. In this particular embodiment, the FDD system 400 accepts input from the supply air sensor 402 including thermistor, carbon monoxide sensor and air flow sensor. In order to measure the temperature of the flue gas, thermistor 406 is also installed in the flue gas path. In this exemplary embodiment, because the FDD system 400 is installed in the return air path (as shown in FIG. 1), the FDD system 400 has internal thermistor 408 and humidity sensor 410 to measure the return air characteristics. While not shown in FIG. 4, the FDD system 400 may also accept measurements from sensors or receive communications from external systems, for example, a weather network server, about the external conditions to the HVAC equipment.

The sensors 402-410 are connected to the signal conditioner 412, the output of which is coupled to the analog to digital converter (ADC) 414. Once the readings from the sensors are converted into digital format by the ADC 414, the information is used by the microcontroller 416 for processing. The microcontroller 416 takes the plurality of classifier parameters calculated during the training phase and produces a classifier score that is communicated to the wireless transceiver 418. A wireless transceiver 418 may be used by the FDD system 400 to communicate to a remote server. The remote server confirms the performance of the HVAC equipment using the information provided by the FDD system 400. The remote server may then communicate further information or instructions to the FDD system 400. The wireless transceiver 418 may also be used to allow the technician or homeowner to monitor and correct system performance by communicating with the FDD system 400. Once the communication with the remote server is complete, and the next step determined, it is used by the digital I/O 420 to control the HVAC equipment through the HVAC control relay 424, which is coupled to the HVAC control board 430. In one embodiment, the thermostat 440 is also connected to the FDD system 400. The FDD system 400 may be remotely commanded to give control of the HVAC equipment to the thermostat. Furthermore, the homeowner may use the FDD system bypass switch 422 to disable the control of the HVAC equipment by the FDD system 400. The bypass switch 422 may be used if the FDD system 400 is malfunctioning. In a further embodiment, a humidifier 450 may be coupled to the HVAC control relay 424. This allows the FDD system 400 to also control humidity in the home.

### Operation of the FDD System

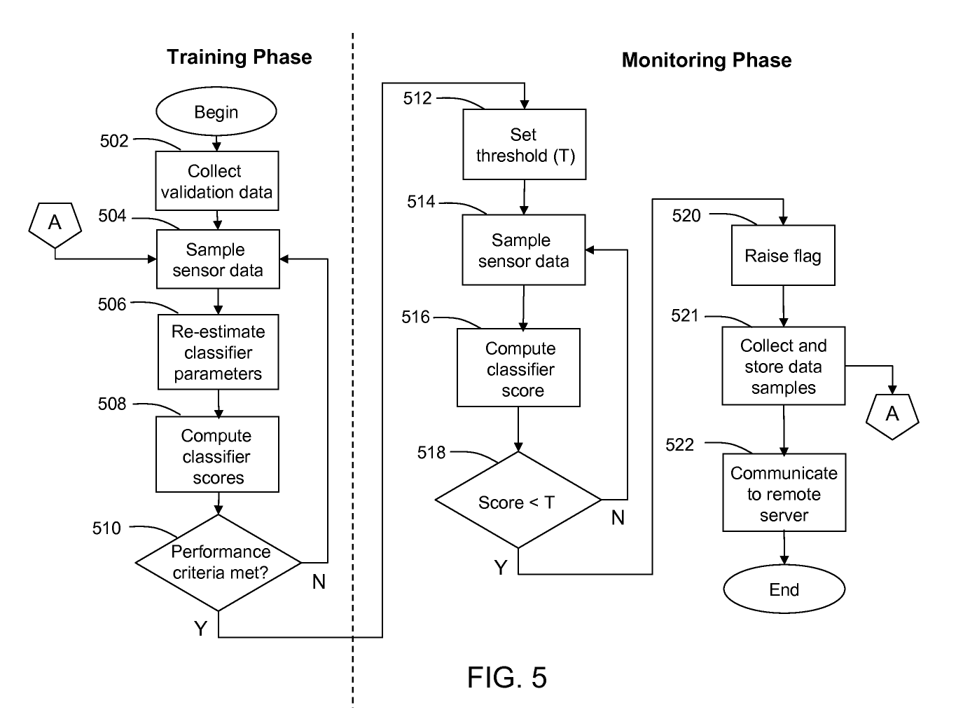

Referring to FIGS. 3, 4 and 5, the operation of the FDD system in accordance with an embodiment of the present invention will be explained in detail. Prior to operating the system, the homeowner or the technician installs the sensors 402, and 406 and FDD system 400. Other sensors to measure environmental conditions such as room temperature and outside temperature may also be installed. The thermostat 440 and HVAC control board 430 are also connected to the FDD system 400.

Before starting the training phase for the classifier 3080 modelling the normal behaviour of the HVAC equipment in situ, the technician or homeowner ensures that the HVAC equipment is operating properly, for that purpose, a communication to the remote server may need to be established. With the connection in place, the technician or homeowner commences the training phase, for example via the Internet to the FDD system 400 or by pressing the reset button 426.

During the training phase, the classifier 3080 modelling the behaviour of the HVAC equipment in situ is initiated and trained. When the FDD system 400 is activated, step 502 may be employed to collect normal data samples corresponding to the normal steady state or transient state behaviour of the HVAC equipment, as installed in situ in the operation environment. This initial ‘normal’ validation data may serve for cross validation of classifier 3080 performance in modelling the normal behaviour of the HVAC equipment in situ.

The training phase consists in repeatedly sampling sensor measurements from the HVAC equipment and the environment where the HVAC equipment is installed 504. For each sample, the classifier's parameters are re-estimated 506, and the classification scores are calculated using the validation data 508. As discussed above, in the exemplary training phase, the validation data is initially collected at step 502. Finally, the scores computed over validation samples allow assessing the overall performance of classifier 3080. As an example, performance may be computed as the log-likelihood of an HMM classifier over all validation samples. The iterative sampling 504, re-estimating of parameters 506 and calculating of scores 508 make up what is referred to as “on-line” learning of classification parameters. This term refers to the training of the FDD system 400 using real data samples as they are measured from the HVAC equipment as installed, serviced or modified in situ. On-line learning is repeated until some performance criterion for the on-line learning is met 510. For example, as an criterion, classifier performance may be monitored to determine if it is constant over a pre-defined number, N, of successive samples. Alternatively or additionally, the on-line learning may be repeated until a maximum number of samples, Nₘₐₓ, are collected. Finally, learning may also end by using some stopping classifier-specific criteria that does not depend on validation data.

If the training phase is performed shortly after installation of the HVAC equipment, the sampled data should closely reflect the initial data collected at step 502. However, if the training phase is initiated many years since the installation, for example but not limited to after major service, modification or replacement to the HVAC equipment, the sampled data at step 504 may differ significantly from initial data measured at step 502. Despite the difference, the HVAC equipment may still be running optimally with the altered components. In such a case, the technician may re-initiate step 502 to recollect the validation data, which is representative of the normal behaviour of the HVAC equipment. Thus, by training the classifier using initial data collecting 502 and sampling 504, the classifier is able to evolve and change with the life of the HVAC equipment.

With the classifier parameters refined during the on-line learning process, the decision threshold T is set at step 512. The decision threshold T may be set using, for example, statistical property of the classifier, confidence limits, and a cost analysis for different types of errors. Alternatively, the decision threshold T may be set using a cost-sensitive Receiver Operational Characteristic (ROC) analysis. The classifier parameters and decision threshold are stored in memory.

After training classifier 3080 in situ, the FDD system 400 may enter the monitoring phase. During this phase, the FDD system 400 samples the HVAC equipment and the external conditions 514, and calculates the classifier score 516. Unlike calculation step 508 of the training phase, in calculation step 516, the classifier scores is not computed over several validation samples as in step 502. Instead, during the monitoring phase, the classifier score is computed by presenting a new data sample measured during operations (see Step 514) to classifier 3080. The score is then compared to the threshold T (step 518) determined during the training phase. Steps 514, 516, and 518 are repeated at a predetermined interval during the monitoring phase. Referring also to FIG. 3, when classifier score falls below the decision threshold in the case of efficiency monitoring 3100, 518, a flag is raised (step 520), which is communicated to the remote server for further instructions (step 522). Information related to the flag may be stored in memory for future analysis and training. Additionally, for each classifier score computed at step 516, the FDD system 400 may also estimate the degradation in performance of the HVAC equipment.

A flag is an indication that the HVAC equipment has deviated from the normal behaviour. However, the specific reason for the deviation is not yet known until the HVAC equipment is diagnosed. The diagnosis may be carried out remotely by a technician or, if necessary, the technician may diagnose the problem on site. Once the cause of the deviation in the performance is determined, the FDD system 400 may be trained to detect the specific fault condition. Referring to FIG. 3, the classification system 308 is composed of N classifiers 3080, 3081, . . . , 308N. Classifier 3080 models the normal behaviour of the HVAC equipment, while classifiers 3081, . . . , 308N model a respective specific fault condition of the HVAC equipment. If the performance of the HVAC equipment had never deviated from normal behaviour, the classification system 308 may only have classifier 3080 that models the normal behaviour of the HVAC equipment. Subsequently, for each flag raised, the FDD system stores data samples and other pertinent information, and uses this information to train other fault condition classifiers 3081, . . . , 308N. After each flag is diagnosed, for example, flag was raised because of a malfunctioning compressor, the FDD system is trained for new fault condition classifiers. At this point, the HVAC equipment is presumably still running abnormally as the problem has been diagnosed but not yet fixed. Data samples collected at Step 521 provide ‘abnormal’ data for train and validate classifiers 3081, . . . , 308N. Thereafter, the classifier parameters are estimated using the stored information, that is the information stored when the flag was raised, at step 521. The steps 504-508 are repeated until the exit condition is met at step 510. The threshold is then set at step 512. Over time, a new classifier is trained to model each specific abnormal behaviour. With each of the classifiers 3081, . . . , 308N, the FDD system can monitor for a respective specific fault condition that was identified and diagnosed by the technician. Referring also to FIG. 3, the classifier score is compared 518 to one of the thresholds T₁, . . . , T_{N} for each of the classifiers 3081, . . . , 308N. In the case of fault monitoring, a flag is raised 520 when the score exceeded a threshold. For example, the technician may determine that the condition generating the flag was related to a leaking refrigerant. After the diagnosis, the technician trains a new classifier to detect for this specific fault condition by using the data samples and conditions that generated the flag. In future monitoring of the HVAC equipment, the new classifier should be able to detect the specific fault condition and self-diagnose the problem.

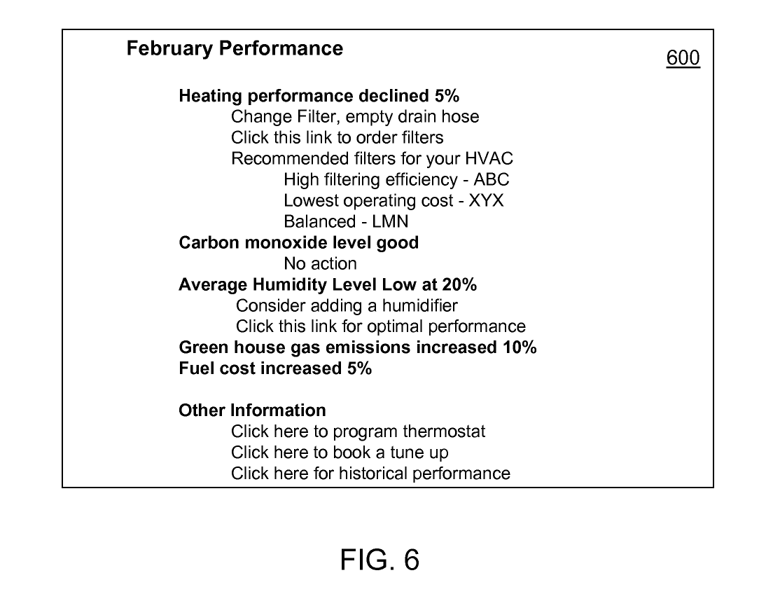

As more classifiers 3081, . . . , 308N are trained to detect specific fault conditions, the FDD system is able to pro-actively diagnose more problems in the HVAC equipment. This information may be used in a variety of ways. For example, the technician may use the information to remotely control the HVAC equipment to fix problems without travelling to the site. In other instances, the technician may personally contact the homeowner with possible fixes to improve the performance of the HVAC equipment or to schedule an appointment for on-site maintenance. In another embodiment of the invention, the remote server may generate an e-mail containing detailed information and recommendation for the owner. Such an e-mail may include possible fixes to the fault detected by the remote server and other recommendations to improve the general health of the HVAC equipment. Furthermore, the remote server may send monthly e-mails about the performance of the HVAC equipment. As an illustration, FIG. 6 shows information about performance for the month of February that may be included in the monthly e-mail. Since February is a cold month, the e-mail contains information related to the heating performance of the HVAC equipment. As it has detected a decline in performance, several suggestions are provided, including recommended parts for purchase. Related to comfort is the humidity level. Because the remote server detected a low level of humidity, it has suggested the addition of a humidifier. Various other useful information may be incorporated for the homeowner.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

One or more embodiments have been described by way of example. It will be apparent to persons skilled in the art that a number of variations and modifications can be made without departing from the scope of the invention as defined in the claims.

What is claimed is:

1. A system for detecting and diagnosing faults in heating, ventilating and air conditioning (HVAC) equipment, comprising:
a sensor;
a classifier modelling a normal behaviour of the HVAC equipment in situ in the installed operation environment, the classifier having a plurality of classifier parameters for computing a classifier score using an input data based on a measured value from the sensor, the plurality of classifier parameters being created during a training phase of the system using the input data during the training phase; and
a decision module for comparing the classifier score to a decision threshold, the decision threshold being set during the training phase.

2. The system according to claim 1, further comprising:
a second classifier modelling a fault condition of the HVAC equipment, the second classifier having a plurality of classifier parameters for computing a second classifier score using the input data, the plurality of classifier parameters being created during the training phase using the fault condition of the HVAC equipment detected during a monitoring phase of the system.

3. The system according to claim 1, further comprising:
a communication module for communicating the classifier score to a remote server when the classifier score is below the decision threshold and for receiving instructions from the remote server; and
a control module for controlling the HVAC equipment based on the instructions from the remote server.

4. The system according to claim 1, further comprising a filtering and converting module for filtering and converting the measured value from the sensor into digital data, the digital data being the input data to the classifier.

5. The system according to claim 4, wherein, during a transient state operation, the digital data is further input into a windowing module for extracting invariant and discriminate features, the windowing module outputting the input data for the classifier.

6. The system according to claim 1, further comprising a performance degradation estimator for estimating degradation in performance of the HVAC equipment based on the classifier score and the input data.

7. The system according to claim 6, wherein the performance degradation estimator estimates degradation in efficiency.

8. The system according to claim 1, further comprising a memory for storing the plurality of classifier parameters, the decision threshold, the measured value and the input data used during the training phase.

9. The system according to claim 1, wherein the communication module includes a wireless transceiver for communicating with the remote server.

10. The system according to claim 1, further comprising a thermostat bypass relay to enable and disable overriding of the control module by a local switch or remote server.

11. The system according to claim 1, wherein the sensor is selected from the group consisting of: a flue gas temperature sensor, a return air temperature sensor, a return air humidity level sensor, a supply air temperature sensor, a supply air flow sensor, a supply air carbon monoxide level sensor, an outside temperature sensor, an outside humidity level sensor, a room temperature sensor, a room humidity level sensor and a combination thereof.

12. A method for detecting and diagnosing faults in heating, ventilating and air conditioning (HVAC) equipment, comprising:
measuring an input data from a sensor;
inputting the input data from the sensor into a classifier modelling a normal behaviour of the HVAC equipment in situ in the installed operation environment, the classifier having a plurality of classifier parameters determined during a training phase of the classifier;
calculating a classifier score using the plurality of classifier parameters and the input data;
comparing the classifier score to a decision threshold set during the training phase; and
communicating the classifier score to a remote server.

13. The method according to claim 12, wherein the training phase comprises:
sampling the sensor and estimating the plurality of classifier parameters;
calculating the classifier score using the plurality of classifier parameters and the initial data until the classifier score is constant over a pre-defined number of successive repetitions or until a maximum number of repetitions are performed; and
setting the decision threshold based on the plurality of classifier parameters.

14. The method according to claim 12, further comprising:
diagnosing the HVAC equipment to determine a fault condition;
storing information related to the fault condition;
creating a second classifier modelling the fault condition, the second classifier having a second plurality of classifier parameters based on the stored information;
training the second classifier comprising:
sampling the sensor;
estimating the second plurality of classifier parameters based on the stored information related to the fault condition;
calculating the classifier score using the second plurality of classifier parameters and the sampled data from the second sensor until the classifier score is constant over a pre-defined number of successive repetitions or until a maximum number of repetitions are performed; and
setting the decision threshold based on the plurality of classifier parameters; and
monitoring the HVAC equipment with the classifier modelling the normal behaviour and the classifier modelling the fault condition of the HVAC equipment.

15. The method according to claim 14, wherein the stored information comprises the measured data, the input data, the classifier score, the classifier parameters, and the decision threshold related to the fault condition.

16. The method according to claim 12, wherein inputting comprises filtering and converting the measured data from the sensor into digital data, the digital data being the input data to the classifier.

17. The method according to claim 16, wherein, during a transient state operation, inputting further comprises extracting invariant and discriminate features from the digital data, the digital data being the input data to the classifier.

18. The method according to claim 12, further comprising:
estimating degradation in performance of the HVAC equipment based on the input data and the classifier score.
